(19) United States
(12) Patent Application Publication
(10) Pub. No.: US 2009/0013739 A1
(43) Pub. Date: Jan. 15, 2009

(54) Entry door security device

(76) Inventor: Edward J. Vyskocil, JR., Topeka, KS (US)

Correspondence Address: D. A. N. Chase/Chase Law Firm, L.C., Suite 130, 4400 College Boulevard, Overland Park, KS, 66211, US

(21) Appl. No.: 12/214,713

(22) Filed: Jun. 20, 2008

Related U.S. Application Data
(60) Provisional application No. 60/936,579, filed on Jun. 21, 2007.

(51) Int. Cl. E05B 17/18; E05D 7/00; E05D 5/10

(52) U.S. Cl. 70/416; 16/221; 16/386

(57) ABSTRACT

A security device is disclosed for use with an entry door lock accessible from an exterior side of the door and having a rotatable element on an interior side of the door for engaging and disengaging the lock. A lock stop precludes rotation by providing a pair of spaced stop members that receive the rotatable element in its locked position and prevent rotation thereof to its unlocked position, whereby unlocking the door from the exterior side is precluded.

### CROSS REFERENCE TO RELATED APPLICATION

This application claims the benefit of provisional application No. 60/936,579, filed Jun. 21, 2007, entitled “DEAD LOC” ENTRY DOOR SECURING DEVICE.

### FIELD OF THE INVENTION

This invention relates to a device for securing the lock on an entry door to prevent unauthorized access by lock bumping or other lock picking techniques.

### BACKGROUND OF THE INVENTION

Homes in particular are exposed to a break-in by forced entry through a locked exterior door thought to be secure. Deadbolt locks are commonly used for increased security but they can be overcome by lock bumping and other lock picking techniques. Although break-in time may be materially increased, a deadlock does not assure that unauthorized entry will be precluded. Supplemental locking devices have been proposed and are commercially available which mount on the inside of the door and engage the interior knob of the lock to resist rotation, but there is no assurance that the lock components will be positively held against rotation when a forced entry is attempted.

### SUMMARY OF THE INVENTION

In an embodiment of the present invention the aforementioned problem is addressed by providing a security device that positively prevents unauthorized release of a door lock. An entry door lock accessible from an exterior side of the door has a rotatable knob or element on an interior side of the door for engaging the lock upon rotation to a locked position, and for disengaging the lock upon rotation to an unlocked position. A hinge is secured to the interior side of the door and mounts a lock stop for movement between a first position clear of the rotatable element, and a second position in which the spaced stop members receive the rotatable element when it is in its locked position, thereby preventing rotation thereof to an unlocked position which, if the lock stop is not present, could occur if an intruder on the outside of the door is successful in releasing the lock from the outside by any of a variety of methods including lock bumping or the use of a key without authorization.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a fragmentary view of the interior side of a door and adjacent wall, showing a dead bolt lock and the security lock of the present invention mounted thereabove and in a disabled condition.

FIG. 2 is a view similar to FIG. 1 but showing the security device in use to prevent rotation of the interior rotatable element.

FIG. 3 is a perspective view of the security device only (detached from the door).

FIG. 4 is a fragmentary, elevational view of the door showing a lock and the lock stop as seen viewing the outer edge of the door, the lock stop being in its operative position illustrated in FIG. 2.

FIG. 5 is an enlarged view of the lock stop, hinge and associated components shown in FIG. 4, but detached from the door.

FIG. 6 is a view similar to FIG. 4 but showing a modified form of the present invention for use on double keyed locks.

FIG. 7 is a fragmentary, elevational view of the embodiment of FIG. 6.

### DETAILED DESCRIPTION

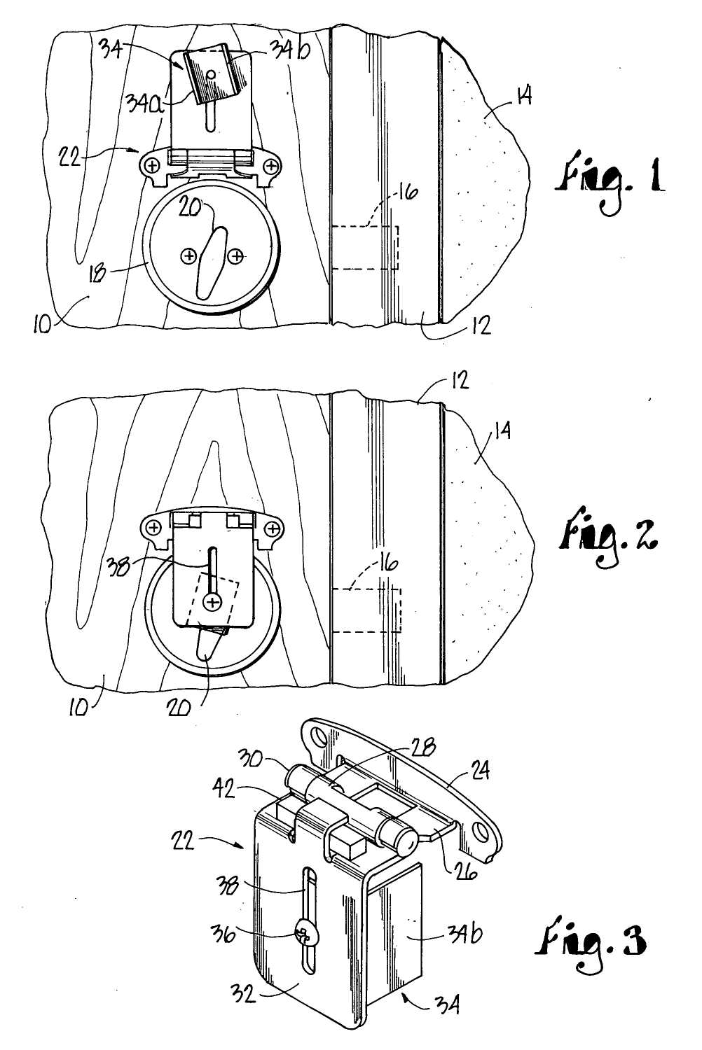

Referring initially to FIGS. 1 and 2, the interior side of a door 10 is shown fragmentarily in a closed position alongside a jamb 12 at an interior wall 14 of a home or other structure. The door 10 is provided with a lock 18 from which bolt 16 extends into jamb 12 in the conventional manner when door lock 18 is in its locked condition illustrated. A rotatable element 20 presents a knob that is manually rotated to lock and unlock the door 10 from the inside, the knob 20 in FIGS. 1 and 2 being shown in the locked position as evidenced by the extended bolt 16. To unlock the door 10 from the inside, the knob element 20 is rotated counter-clockwise from the position shown in FIGS. 1 and 2 to retract the bolt 16.

A first embodiment 22 of the lock stop of the present invention is shown in FIGS. 1-5, and a second, modified embodiment 22a is illustrated in FIGS. 6 and 7.

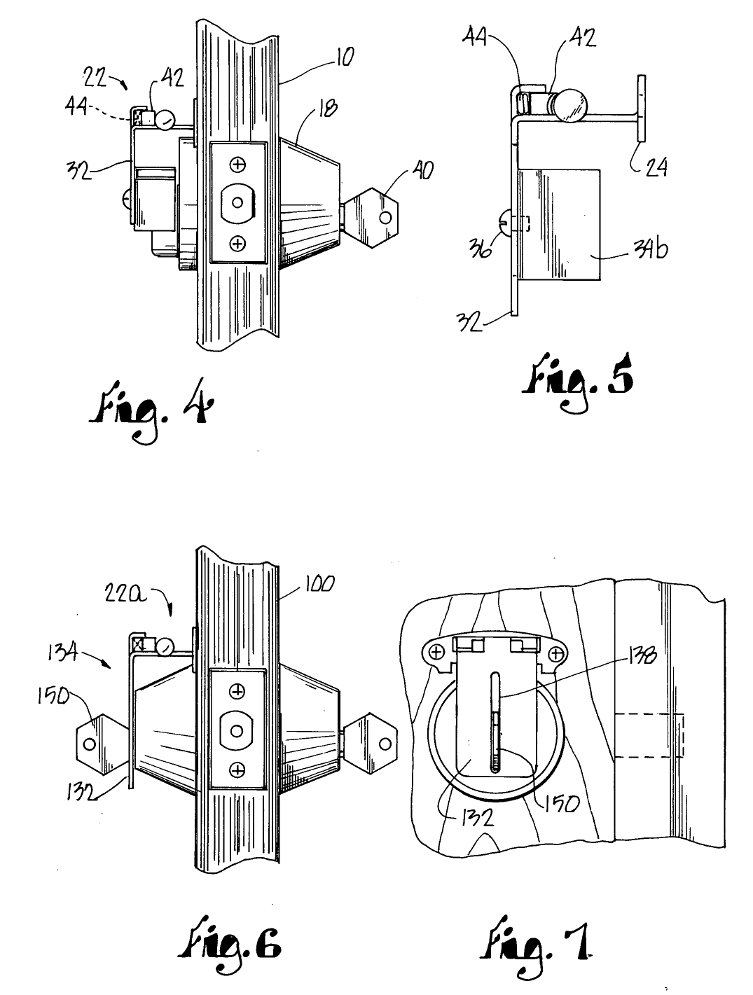

Referring to the perspective view of FIG. 3, the lock stop comprises a mounting plate 24 having two outwardly projecting tabs 26 integral with a hinge barrel 28 that receives a hinge pin 30 which supports a hinge leaf 32 for movement about the axis of pin 30 between an unlocked position in FIG. 1 and a locked position shown in FIGS. 2, 3 and 4. A U-shaped lock stop 34 presents a pair of spaced stop members 34a and 34b and is adjustably mounted on leaf 32 by a screw 36 extending through a slot 38 which, in the locked position shown in FIGS. 2 and 3, extends vertically and permits the lock stop 34 to be adjustably positioned along slot 38 to embrace knob element 20 when the lock stop 22 is in a vertical, closed position as shown in FIGS. 2-4. It will be appreciated that when lock stop 22 is in the closed position, the knob element 20 is captured between stop elements 34a and 34b and thus is restrained against rotation, thereby precluding use of a key 40 (FIG. 4) or other means to unlock the door 10 from the outside. Accordingly, the knob element 20 which is normally used to lock and unlock the deadbolt from the inside of the door 10, is rendered immobile and precludes lock bumping or the use of other lock picking techniques to release the lock 18 from the outside of the door 10.

Furthermore, hinge leaf 32 is firmly held in its locking position shown in FIGS. 2-4 by a self-closing device consisting of a bar 42, preferably of a plastic material, which engages hinge barrel 28 under the bias of a spring 44 (FIG. 4). Bar 42 is thus forceably engaged with the surface of hinge barrel 28 and is in frictional contact therewith. Accordingly, leaf 32 is held in its locking position until the occupant raises the leaf to free the knob element 20.

FIGS. 6 and 7 show a modified embodiment of the present invention for use on double keyed locks. Instead of employing stop members 34a and 34b, the lock stop 134 comprises a flat leaf 132 having a longer slot 138 therein as seen in FIG. 7 which enables the leaf 132 to receive and hold a key 150 inserted in the lock on the interior side of the door 100. The construction and operation of the embodiment of FIGS. 6 and 7 is otherwise identical to the embodiment of FIGS. 1-5.

It is to be understood that while certain forms of this invention have been illustrated and described, it is not limited thereto except insofar as such limitations are included in the following claims.

Having thus described the invention, what is claimed as new and desired to be secured by Letters Patent is as follows:

1. In combination with an entry door lock accessible from an exterior side of the door, wherein the lock has a rotatable element on an interior side of the door for engaging the lock upon rotation to a locked position, and for disengaging the lock upon rotation of said element to an unlocked position:
a lock stop having a pair of spaced stop members, and
hinge structure secured to said interior side and mounting said lock stop for movement between a first position clear of said rotatable element, and a second position in which said spaced stop members receive said rotatable element in its locked position and prevent rotation thereof to its unlocked position, whereby unlocking the door from the exterior side is precluded when the lock stop is in its second position.

2. The invention of claim 1, wherein said hinge structure includes a hinge leaf and a mount securing said hinge leaf to said interior side of the door, and providing an axis for movement of said hinge leaf between said first and second positions.

3. The invention of claim 1, wherein said hinge structure includes a hinge leaf and a mount securing said hinge leaf to said interior side of the door and providing a generally horizontally extending axis for movement of said hinge leaf between said first and second positions, and a generally U-shaped element presenting said stop members and carried by said hinge leaf, said stop members receiving said rotatable element when said hinge leaf is in its second position to prevent rotation thereof.

4. The invention of claim 1, wherein said hinge structure includes a hinge leaf and a mount securing said hinge leaf to said interior side of the door, a hinge pin carried by said mount and providing a generally horizontally extending axis for movement of said hinge leaf between said first and second positions, and a generally U-shaped element presenting said stop members and carried by said hinge leaf, said stop members receiving said rotatable element when said hinge leaf is in its second position to prevent rotation thereof.

5. In combination with an entry door lock accessible from an exterior side of the door, wherein the lock has a rotatable element on an interior side of the door for engaging the lock upon rotation to a locked position, and for disengaging the lock upon rotation of said element to an unlocked position:
a lock stop having a stop member, and
hinge structure secured to said interior side and mounting said lock stop for movement between a first position clear of said rotatable element, and a second position in which said stop member receives said rotatable element in its locked position and prevents rotation thereof to its unlocked position, whereby unlocking the door from the exterior side is precluded when the lock stop is in its second position.
